(19) United States
(12) Patent Application Publication
(10) Pub. No.: US 2026/0038405 A1
(43) Pub. Date: Feb. 5, 2026

(54) DISPLAY PANEL, DISPLAY DEVICE, AND ELECTRONIC APPARATUS

(71) Applicant: Samsung Display Co., Ltd., Yongin-si (KR)

(72) Inventors: HAE-KWAN SEO, Yongin-si (KR); JINYOUNG ROH, Yongin-si (KR); BON-SEOG GU, Yongin-si (KR); JAEKEUN LIM, Yongin-si (KR)

(21) Appl. No.: 19/210,909

(22) Filed: May 16, 2025

(30) Foreign Application Priority Data
Jul. 31, 2024 (KR) 10-2024-0101436

(51) Int. Cl. G09G 3/20

(52) U.S. Cl. CPC G09G 3/2003; G09G 2300/0819; G09G 2300/0842; G09G 2310/08; G09G 2330/021

(57) ABSTRACT

A display panel includes a data line configured to transmit a data voltage for a color, first and second pixel circuits connected to the data line and positioned at a side of the data line, and one or more light-emitting elements connected to the first and second pixel circuits, wherein the first and second pixel circuits include a first transistor configured to control a driving current flowing to a corresponding light-emitting element of the one or more light-emitting elements, a second transistor configured to transmit the data voltage to a first terminal of the first transistor based on a scan signal, a third transistor configured to connect a second terminal and a gate of the first transistor based on the scan signal, and a selection transistor configured to connect the first terminal of the first transistor and a terminal of the second transistor based on a selection signal.

### CROSS-REFERENCE TO RELATED APPLICATION

The present application claims priority to, and the benefit of, Korean Patent Application No. 10-2024-0101436, filed on Jul. 31, 2024, in the Korean Intellectual Property Office, the entire disclosure of which is incorporated herein by reference.

### BACKGROUND

### 1. Field

Embodiments of the present disclosure may relate to a display device. For example, embodiments of the present disclosure may relate to a display device with relatively low power consumption and/or a display panel included in the display device.

### 2. Description of the Related Art

A display device may include a display panel that displays an image. The display panel may include pixels that display a plurality of colors, and data lines that may be to transmit data voltages to the pixels. For example, the pixels may include red pixels, green pixels, and/or blue pixels.

The display device may include a data driver that provides the data voltages to the data lines. The data driver may include channels that output the data voltages to the data lines. If pixels arranged in one row are connected one-to-one to the data lines, the data driver may include substantially the same number of channels as the number of pixels that are arranged in one row, and thus, an area (e.g., size) of the data driver may increase. Further, if each of the channels of the data driver outputs data voltages for a plurality of colors, then the power consumption of the data driver may increase, and thus, power consumption of the display device may increase.

### SUMMARY

Embodiments of the present disclosure may provide a display panel with a reduced dead space (e.g., inactive area).

Embodiments of the present disclosure may provide a display device with reduced power consumption and/or an electronic apparatus including the display device.

A display panel according to embodiments includes a data line configured to transmit a data voltage for a color, a first pixel circuit and a second pixel circuit connected to the data line and positioned at a side of the data line, and one or more light-emitting elements connected to the first pixel circuit and the second pixel circuit, wherein the first pixel circuit and the second pixel circuit include a first transistor configured to control a driving current flowing to a corresponding light-emitting element of the one or more light-emitting elements, a second transistor configured to transmit the data voltage to a first terminal of the first transistor based on a scan signal, a third transistor configured to connect a second terminal and a gate of the first transistor based on the scan signal, and a selection transistor configured to connect the first terminal of the first transistor and a terminal of the second transistor based on a selection signal.

The data voltage may be configured to be written to the first pixel circuit in a period that the scan signal is at an activation level and the selection signal is at a logic low level, wherein the data voltage is configured to be written to the second pixel circuit in a period that the scan signal is at the activation level and the selection signal is at a logic high level, wherein the selection transistor of the first pixel circuit includes a P-type Metal Oxide Semiconductor (PMOS) transistor, and wherein the selection transistor of the second pixel circuit includes an N-type Metal Oxide Semiconductor (NMOS) transistor.

The first pixel circuit and the second pixel circuit may further include a storage capacitor configured to store a signal of the gate of the first transistor, a fourth transistor configured to initialize the storage capacitor based on an initialization gate signal, a fifth transistor configured to transmit a power voltage to the first terminal of the first transistor based on an emission signal, a sixth transistor configured to connect the second terminal of the first transistor and a terminal of the corresponding light-emitting element based on the emission signal, and a seventh transistor configured to initialize the corresponding light-emitting element based on a bypass gate signal.

A display device according to embodiments includes a data driver including a first channel configured to output a first data voltage for a first color, and a second channel configured to output a second data voltage for a second color, a first data line connected to the first channel and configured to transmit the first data voltage, a second data line configured to transmit the second data voltage, a first-first pixel circuit and a first-second pixel circuit arranged in a first row, connected to the first data line, and positioned at a first side of the first data line, a first-third pixel circuit and a first-fourth pixel circuit arranged in a second row, connected to the first data line, and positioned at a second side of the first data line, and first light-emitting elements connected to the first-first pixel circuit, the first-second pixel circuit, the first-third pixel circuit, and the first-fourth pixel circuit.

The display device may further include a second-first pixel circuit and a second-second pixel circuit arranged in the first row, connected to the second data line, and positioned at a first side of the second data line, a second-third pixel circuit and a second-fourth pixel circuit arranged in the second row, connected to the second data line, and positioned at a second side of the second data line, and second light-emitting elements connected to the second-first pixel circuit, the second-second pixel circuit, the second-third pixel circuit, and the second-fourth pixel circuit.

The display device may further include a first scan line in the first row, and connected to the first-first pixel circuit, the first-second pixel circuit, the second-first pixel circuit, and the second-second pixel circuit, and a second scan line in the second row, and connected to the first-third pixel circuit, the first-fourth pixel circuit, the second-third pixel circuit, and the second-fourth pixel circuit.

The display device may further include a third data line configured to transmit a third data voltage for a third color, a third-first pixel circuit and a third-second pixel circuit arranged in the first row, connected to the third data line, and positioned at a first side of the third data line, a third-third pixel circuit and a third-fourth pixel circuit arranged in the second row, connected to the third data line, and positioned at a second side of the third data line, and third light-emitting elements connected to the third-first pixel circuit, the third-second pixel circuit, the third-third pixel circuit, and the third-fourth pixel circuit.

The first light-emitting elements and the second light-emitting elements may be respectively arranged in a same one of the rows as a corresponding one of the pixel circuits connected thereto, wherein the third light-emitting elements are respectively arranged in a different one of the rows from a corresponding one of the pixel circuits connected thereto.

The second light-emitting elements may be respectively arranged in a same one of the rows as a corresponding one of the pixel circuits connected thereto.

The data driver may further include a third channel configured to output the third data voltage, and connected to the third data line.

The display device may further include a second-first data line configured to transmit the second data voltage, a second-first pixel circuit and a second-second pixel circuit arranged in the first row, connected to the second-first data line, and positioned with the second-first data line therebetween, and second-first light-emitting elements connected to the second-first pixel circuit and the second-second pixel circuit.

The display device may further include a first scan line in the first row, and connected to the first-first pixel circuit, the first-second pixel circuit, and the second-first pixel circuit, and a second scan line in the second row, and connected to the first-third pixel circuit, the first-fourth pixel circuit, and the second-second pixel circuit.

The display device may further include a second-second data line configured to transmit the second data voltage, a second-third pixel circuit and a second-fourth pixel circuit arranged in the second row, connected to the second-second data line, and positioned with the second-second data line therebetween, and second-second light-emitting elements connected to the second-third pixel circuit and the second-fourth pixel circuit.

The data driver may further include a second-first channel configured to output the second data voltage, and connected to the second-first data line, and a second-second channel configured to output the second data voltage, and connected to the second-second data line.

The first-first pixel circuit and the first-second pixel circuit may include a first transistor configured to control a driving current to a corresponding one of the first light-emitting elements, a second transistor configured to transmit the first data voltage to a terminal of the first transistor based on a scan signal, a third transistor configured to diode-connect the first transistor based on the scan signal, and a selection transistor configured to connect the terminal of the first transistor and a terminal of the second transistor based on a selection signal, wherein the selection transistor of the first-first pixel circuit includes a P-type Metal Oxide Semiconductor (PMOS) transistor, and wherein the selection transistor of the first-second pixel circuit includes an N-type Metal Oxide Semiconductor (NMOS) transistor.

The first data voltage may be configured to be written to the first-first pixel circuit in a period that the scan signal is at an activation level and that the selection signal is at a logic low level, wherein the first data voltage is configured to be written to the first-second pixel circuit in a period that the scan signal is at the activation level and that the selection signal is at a logic high level.

The first-first pixel circuit and the first-second pixel circuit may include a first transistor configured to control a driving current to a corresponding one of the first light-emitting elements, and a second transistor configured to transmit the first data voltage to a gate of the first transistor based on a scan signal, wherein the first-second pixel circuit further includes a selection transistor configured to connect to the first data line and a terminal of the second transistor based on a selection signal.

The first data voltage may be configured to be written to the first-first pixel circuit and the first-second pixel circuit in a period that the scan signal is at an activation level and that the selection signal is at a logic high level, wherein the first data voltage is configured to be written to the first-first pixel circuit in a period that the scan signal is at the activation level and that the selection signal is at a logic low level.

An electronic apparatus according to embodiments includes a processor configured to output image data, a data driver including a channel configured to output a data voltage for a color based on the image data, and a display panel including a data line connected to the channel, a first pixel circuit and a second pixel circuit connected to the data line and positioned at a side of the data line, and light-emitting elements connected to the first pixel circuit and the second pixel circuit, wherein the first pixel circuit and the second pixel circuit include a first transistor configured to control a driving current to a corresponding one of the light-emitting elements, a second transistor configured to transmit the data voltage to a first terminal of the first transistor based on a scan signal, a third transistor configured to connect a second terminal and a gate of the first transistor based on the scan signal, and a selection transistor configured to connect the first terminal of the first transistor and a terminal of the second transistor based on a selection signal.

The data voltage may be configured to be written to the first pixel circuit in a period that the scan signal is at an activation level and that the selection signal is at a logic low level, wherein the data voltage is written to the second pixel circuit in a period that the scan signal is at the activation level and the selection signal is at a logic high level, wherein the selection transistor of the first pixel circuit includes a P-type Metal Oxide Semiconductor (PMOS) transistor, and wherein the selection transistor of the second pixel circuit includes a N-type Metal Oxide Semiconductor (NMOS) transistor.

In the display panel according to the embodiments, two pixel circuits arranged in one row may be connected to one data line, so that the number of channels of the data driver may be reduced, and the dead space of the display panel may be reduced.

In the display device and the electronic apparatus according to the embodiments, the channel of the data driver may output only a data voltage for one color, so that the power consumption of the data driver may be reduced, and the power consumption of the display device may be reduced.

### BRIEF DESCRIPTION OF THE DRAWINGS

The above and other aspects of the present disclosure will be more clearly understood by describing in detail embodiments thereof with reference to the accompanying drawings, in which:

FIG. 1 is a block diagram illustrating a display device according to embodiments of the present disclosure.

FIG. 2 is a circuit diagram illustrating examples of a first pixel circuit and a second pixel circuit of FIG. 1.

FIG. 3 is a timing diagram illustrating examples of signals that may be applied to the first pixel circuit and the second pixel circuit of FIG. 2.

FIG. 4 is a circuit diagram illustrating examples of the first pixel and the second pixel of FIG. 1.

FIG. 5 is a timing diagram illustrating examples of signals that may be applied to the first pixel circuit and the second pixel circuit of FIG. 4. FIG. 6 is a circuit diagram illustrating examples of the first pixel circuit and the second pixel circuit of FIG. 1.

FIG. 7 is a timing diagram illustrating examples of signals that may be applied to the first pixel circuit and the second pixel circuit of FIG. 6.

FIG. 8 is a diagram illustrating an example of a display panel and a data driver according to embodiments of the present disclosure.

FIG. 9 is a timing diagram illustrating examples of data voltages that may be transmitted by the data lines of FIG. 8 and examples of scan signals that may be transmitted by the scan lines of FIG. 8.

FIG. 10 is a diagram illustrating examples of pixel circuits and light-emitting elements according to embodiments of the present disclosure.

FIG. 11 is a diagram illustrating examples of pixel circuits and light-emitting elements according to embodiments of the present disclosure.

FIG. 12 is a diagram illustrating examples of pixel circuits and light-emitting elements according to embodiments of the present disclosure.

FIG. 13 is a diagram illustrating examples of a display panel and a data driver according to embodiments of the present disclosure.

FIG. 14 is a timing diagram illustrating examples of data voltages that may be transmitted by the data lines of FIG. 13 and examples of scan signals that may be transmitted by the scan lines of FIG. 13.

FIG. 15 is a block diagram illustrating an electronic apparatus according to embodiments of the present disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing embodiments corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

It will be understood that when an element, layer, region, or component (e.g., an apparatus, a device, a circuit, a wire, an electrode, a terminal, a conductive film, and/or the like) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” and/or the like, may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” and/or the like. may also be used herein to differentiate different categories or sets of elements. For conciseness, the terms “first,” “second,” and/or the like may represent “first-category (or first-set),” “second-category (or second-set),” and/or the like, respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

The electronic or electric devices and/or any other relevant devices or components according to embodiments of the present disclosure described herein may be implemented utilizing any suitable hardware, firmware (e.g., an application-specific integrated circuit), software, or a combination of software, firmware, and hardware, to process data or digital signals. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Circuit hardware may include, for example, application specific integrated circuits (ASICs), general purpose or special purpose central processing units (CPUs) that is configured to execute instructions stored in a non-transitory storage medium, digital signal processors (DSPs), graphics processing units (GPUs), and programmable logic devices, such as field programmable gate arrays (FPGAs).

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Hereinafter, a display panel, a display device, and an electronic apparatus according to embodiments of the present disclosure will be described in more detail with reference to the accompanying drawings. The same or similar reference numerals will be used for the same elements in the accompanying drawings.

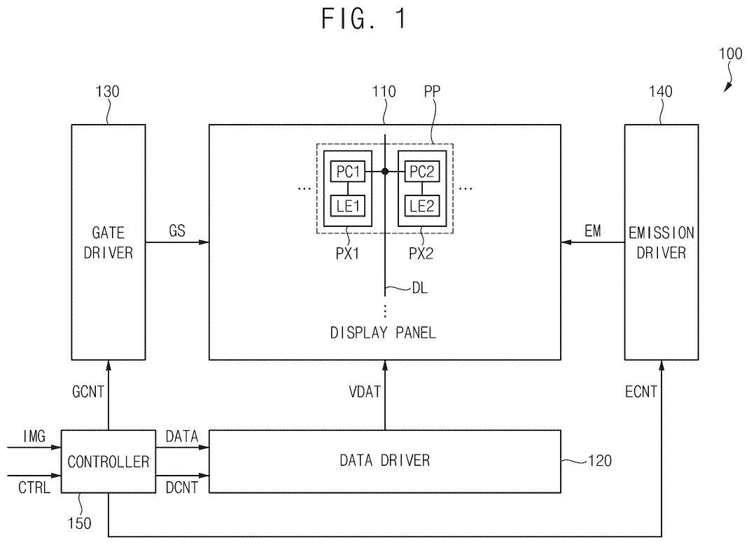

FIG. 1 is a block diagram illustrating a display device 100 according to embodiments of the present disclosure.

Referring to FIG. 1, the display device 100 may include a display panel 110, a data driver 120, a gate driver 130, an emission driver 140, and/or a controller 150.

The display panel 110 may include a plurality of pixel pairs PP. One or more of the pixel pairs PP may include a first pixel PX1 and/or a second pixel PX2 (as used herein, “one or more of” may mean “each of,” as appropriate). The first pixel PX1 and the second pixel PX2 may display a substantially similar color (e.g., same color). The first pixel PX1 may include a first pixel circuit PC1 and/or a first light-emitting element LE1 connected to the first pixel circuit PC1. The second pixel PX2 may include a second pixel circuit PC2 and/or a second light-emitting element LE2 connected to the second pixel circuit PC2. A color displayed by the first light-emitting element LE1 may be substantially the same as a color displayed by the second light-emitting element LE2.

The first pixel circuit PC1 and the second pixel circuit PC2 may be arranged in a (e.g., the same) row. The first pixel circuit PC1 and the second pixel circuit PC2 may be connected to a (e.g., the same) data line DL. In one or more embodiments, the first pixel circuit PC1 and the second pixel circuit PC2 may share a (e.g., the same) data line DL.

The data driver 120 may provide one or more data voltages VDAT to the display panel 110. The data driver 120 may generate the data voltages VDAT based on a data signal DATA and/or a data control signal DCNT (as used herein, “based on” may mean “in response to,” or “corresponding to,” as appropriate). The data driver 120 may convert the data signal DATA, which may be a digital signal, into the voltage VDAT, which may be an analog signal. The data control signal DCNT may include a data clock signal, a load signal, and/or the like.

The gate driver 130 may provide one or more gate signals GS to the display panel 110. The gate driver 130 may generate the gate signals GS based on a gate control signal GCNT. The gate control signal GCNT may include a gate clock signal, a gate start signal, and/or the like.

The emission driver 140 may provide one or more emission signals EM to the display panel 110. The emission driver 140 may generate the emission signals EM based on an emission control signal ECNT. The emission control signal ECNT may include an emission clock signal, an emission start signal, and/or the like.

The controller 150 may control an operation of the data driver 120, an operation of the gate driver 130, and/or an operation of the gate driver 130. The controller 150 may provide the data signal DATA and the data control signal DCNT to the data driver 120, may provide the gate control signal GCNT to the gate driver 130, and/or may provide the emission control signal ECNT to the emission driver 140. The controller 150 may generate the data signal DATA, the data control signal DCNT, the gate control signal GCNT, and/or the emission control signal ECNT based on image data IMG and/or a controller control signal CTRL. The controller control signal CTRL may include a master clock signal, a vertical synchronization signal, a horizontal synchronization signal, a data enable signal, and/or the like.

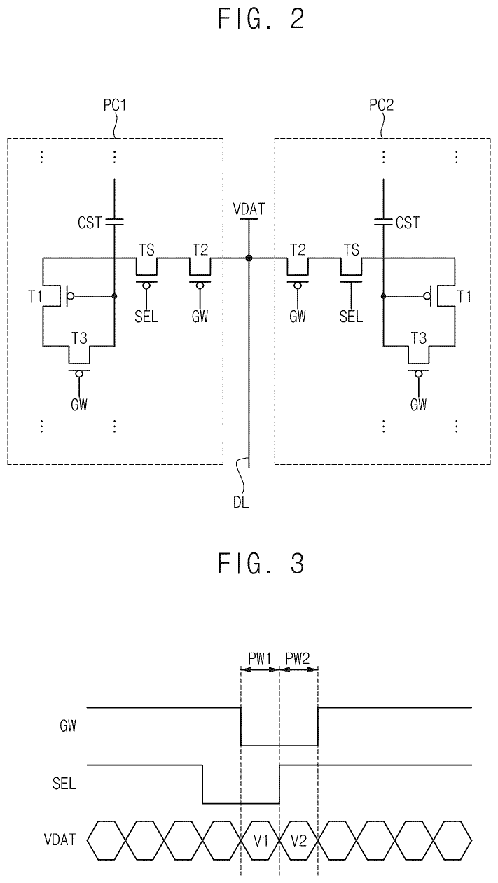

FIG. 2 is a circuit diagram illustrating an example of the first pixel circuit PC1 and the second pixel circuit PC2 of FIG. 1. FIG. 3 is a timing diagram illustrating the signals GW, SEL, and VDAT that may be applied to the first pixel circuit PC1 and/or the second pixel circuit PC2 of FIG. 2.

Referring to FIGS. 1 to 3, the first pixel circuit PC1 and/or the second pixel circuit PC2 may receive a scan signal GW, a selection signal SEL, the data voltage VDAT, and/or the like. The gate signal GS may include the scan signal GW, the selection signal SEL, and/or the like. The first pixel circuit PC1 and/or the second pixel circuit PC2 may include (e.g., each include) a first transistor T1, a second transistor T2, a third transistor T3, a storage capacitor CST, a selection transistor TS, and/or the like. The first pixel circuit PC1 and/or the second pixel PC2 may compensate for a threshold voltage of the first transistor T1, for example in a diode-connected type arrangement (e.g., diode-connect the first transistor T1).

The first transistor T1 may be to control a current (e.g., driving current) that may flow to a light-emitting element. The second transistor T2 may be to transmit the data voltage VDAT to a first terminal (e.g., a source) of the first transistor T1 based on the scan signal GW. The third transistor T3 may be arranged to diode-connect the first transistor T1 (connect a second terminal (e.g., a drain) and a gate of the first transistor T1) based on the scan signal GW. The storage capacitor CST may be to store a signal of the gate of the first transistor T1. The selection transistor TS may be to connect the first terminal (e.g., a source) of the first transistor T1 and a second terminal (e.g., a drain) of the second transistor T2 based on the selection signal SEL.

In one or more embodiments, the selection transistor TS of the first pixel circuit PC1 may be a P-type Metal Oxide Semiconductor (PMOS) transistor, and the selection transistor TS of the second pixel circuit PC2 may be an N-type Metal Oxide Semiconductor (NMOS) transistor.

In a period PW1 and PW2 the scan signal GW may go to an activation level (e.g., a logic low level), and the second transistor T2 and/or the third transistor T3 may be turned on, and the gate and the second terminal (e.g., a drain) of the first transistor T1 may be connected. Accordingly, the first transistor T1 may be diode-connected.

In a period PW1, the scan signal GW may go to an activation level, the selection signal SEL may be at a logic low level, the data line DL may transmit a data voltage V1 for the first pixel circuit PC1, the selection transistor TS of the first pixel circuit PC1 may be turned on, and the selection transistor TS of the second pixel circuit PC2 may be turned off. Accordingly, the data voltage V1, which may compensate for a threshold voltage of the first transistor T1 of the first pixel circuit PC1, may be stored in the storage capacitor CST of the first pixel circuit PC1 through the second transistor T2, the selection transistor TS, the first transistor T1, and the third transistor T3 of the first pixel circuit PC1, and the data voltage V1 for the first pixel circuit PC1 may be written to the first pixel circuit PC1.

In a period PW2 the scan signal GW may be at the activation level and the selection signal SEL may go to a logic high level, the data line DL may transmit a data voltage V2 for the second pixel circuit PC2, the selection transistor TS of the first pixel circuit PC1 may be turned off, and the selection transistor TS of the second pixel circuit PC2 may be turned on. Accordingly, the data voltage V2, which may compensate for a threshold voltage of the first transistor T1 of the second pixel circuit PC2, may be stored in the storage capacitor CST of the second pixel circuit PC2 through the second transistor T2, the selection transistor TS, the first transistor T1, and the third transistor T3 of the second pixel circuit PC2, and the data voltage V2 for the second pixel circuit PC2 may be written to the second pixel circuit PC2.

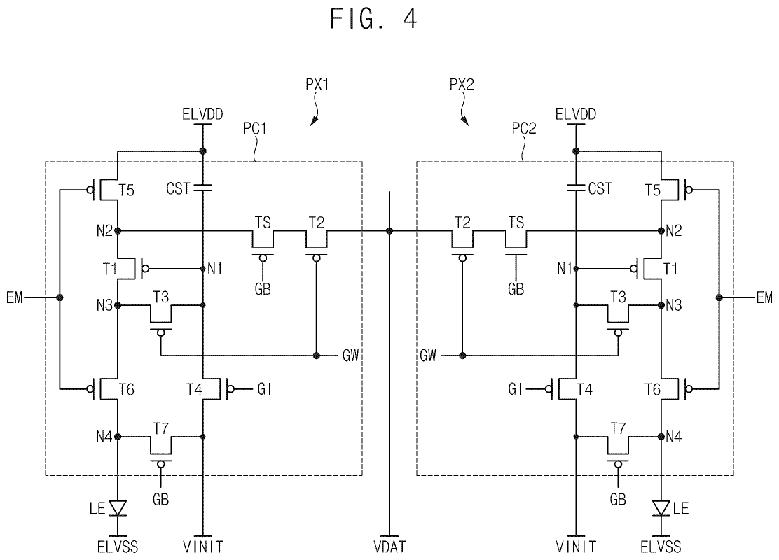

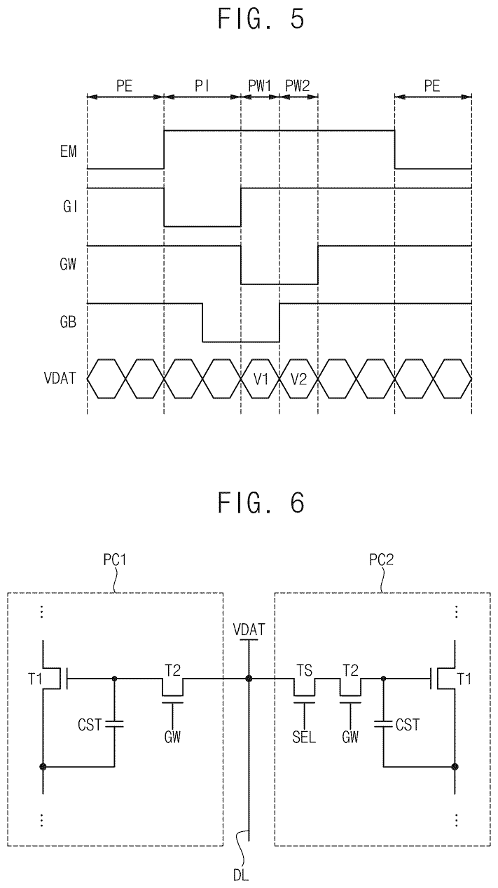

FIG. 4 is a circuit diagram illustrating an example of the first pixel PX1 and the second pixel PX2 of FIG. 1. FIG. 5 is a timing diagram illustrating the signals EM, GI, GW, GB, and VDAT that may be applied to the first pixel circuit PC1 and/or the second pixel circuit PC2 of FIG. 4.

Referring to FIGS. 1, 4, and 5, the first pixel PX1 and/or the second pixel PX2 may receive the scan signal GW, an initialization gate signal GI, a bypass gate signal GB, the emission signal EM, the data voltage VDAT, an initialization voltage VINIT, a first power voltage ELVDD, and/or a second power voltage ELVSS. The gate signal GS may include the scan signal GW, the initialization gate signal GI, and/or the bypass gate signal GB. The first pixel PX1 may include a first pixel circuit PC1, the second pixel PX2 may include a second pixel circuit PC2, the first pixel PX1 may further include a light-emitting element LE, and the second PX2 may further include a light-emitting element LE. Aspects (e.g., components and/or functions) of the first pixel circuit PC1 and the second pixel circuit PC2 described with reference to FIGS. 4 and 5, which are substantially the same as and/or similar to those of the first pixel circuit PC1 and the second pixel circuit PC2 that are described with reference to FIGS. 2 and 3, may not be repeated.

The first transistor T1 may be to control a current (e.g., driving current) that may flow to the light-emitting element LE. The first transistor T1 may include a gate connected to a first node N1, a first terminal (e.g., a source) connected to a second node N2, and a second terminal (e.g., a drain) connected to a third node N3.

The second transistor T2 may be to transmit the data voltage VDAT to the first terminal of the first transistor T1 based on the scan signal GW. The second transistor T2 may include a gate that receives the scan signal GW, a first terminal (e.g., a source) connected to the data line DL, and a second terminal (e.g., a drain).

The third transistor T3 may be arranged to diode-connect the first transistor T1 (connect the second terminal (e.g., a drain) and the gate of the first transistor T1) based on the scan signal GW. The third transistor T3 may include a gate that receives the scan signal GW, a first terminal (e.g., a source) connected to the third node N3, and a second terminal (e.g., a drain) connected to the first node N1.

The storage capacitor CST may be to store a signal of the gate of the first transistor T1. The storage capacitor CST may include a first terminal connected to the first node N1 and a second terminal that receives the first power voltage ELVDD.

The fourth transistor T4 may be to initialize the storage capacitor CST based on the initialization gate signal GI. The fourth transistor T4 may include a gate that receives the initialization gate signal GI, a first terminal (e.g., a source) that receives the initialization voltage VINIT, and a second terminal (e.g., a drain) connected to the first node N1.

The fifth transistor T5 may be to transmit the first power voltage ELVDD to the second node N2 based on the emission signal EM. The fifth transistor T5 may include a gate that receives the emission signal EM, a first terminal (e.g., a source) that receives the first power voltage ELVDD, and a second terminal (e.g., a drain) connected to the second node N2.

The sixth transistor T6 may be connected to the third node N3 and a fourth node N4 based on the emission signal EM. The sixth transistor T6 may include a gate that receives the emission signal EM, a first terminal (e.g., a source) connected to the third node N3, and a second terminal (e.g., a drain) connected to the fourth node N4.

The seventh transistor T7 may be to initialize the light-emitting element LE based on the bypass gate signal GB. The seventh transistor T7 may include a gate that receives the bypass gate signal GB, a first terminal (e.g., a source) that receives the initialization voltage VINIT, and a second terminal (e.g., a drain) connected to the fourth node N4.

The selection transistor TS may connect the first terminal of the first transistor T1 and the second terminal of the second transistor T2 based on the bypass gate signal GB. The selection transistor TS may include a gate that receives the bypass gate signal GB, a first terminal (e.g., a source) connected to the second terminal (e.g., a drain) of a second transistor T2, and the second terminal (e.g., a drain) connected to the second node N2.

In a period PI the initialization gate signal GI may go to an activation level (e.g., a logic low level), the fourth transistor T4 may be turned on, and the initialization voltage VINIT may be transmitted to the first node N1. Accordingly, the storage capacitor CST may be initialized.

In a period PI the bypass gate signal GB may go to an activation level (e.g., a logic low level), the seventh transistor T7 may be turned on, and the initialization voltage VINIT may be transmitted to the fourth node N4. Accordingly, the light-emitting element LE may be initialized.

In a period PW1 and PW2 the scan signal GW may go to an activation level (e.g., a logic low level), the second and third transistors T2 and T3 may be turned on, and the gate and the second terminal (e.g., a drain) of the first transistor T1 may be connected. Accordingly, the first transistor T1 may be diode-connected.

In a period PW1, the scan signal GW may go to the activation level, the bypass gate signal GB may be at a logic low level, the data line DL may transmit the data voltage V1 for the first pixel circuit PC1, the selection transistor TS of the first pixel circuit PC1 may be turned on, and the selection transistor TS of the second pixel circuit PC2 may be turned off. Accordingly, the data voltage V1, which may compensate for the threshold voltage of the first transistor T1 of the first pixel circuit PC1, may be stored in the storage capacitor CST of the first pixel circuit PC1 through the second transistor T2, the selection transistor TS, the first transistor T1, and the third transistor T3 of the first pixel circuit PC1, and the data voltage V1 for the first pixel circuit PC1 may be written to the first pixel circuit PC1.

In a period PW2, the scan signal GW may be at the activation level, the bypass gate signal GB may go to a logic high level, the data line DL may transmit the data voltage V2 for the second pixel circuit PC2, the selection transistor TS of the first pixel circuit PC1 may be turned off, and the selection transistor TS of the second pixel circuit PC2 may be turned on. Accordingly, the data voltage V2, which may compensate for the threshold voltage of the first transistor T1 of the second pixel circuit PC2, may be stored in the storage capacitor CST of the second pixel circuit PC2 through the second transistor T2, the selection transistor TS, the first transistor T1, and the third transistor T3 of the second pixel circuit PC2, and the data voltage V2 for the second pixel circuit PC2 may be written to the second pixel circuit PC2.

In one or more embodiments, the second transistor T2 may be turned on in a period, and the selection transistor TS (arranged between the second transistor T2 and the first transistor T1) may receive the bypass gate signal GB that changes from the logic low level to the logic high level, such that the first pixel circuit PC1 and the second pixel circuit PC2 connected to (e.g., sharing) the data line DL may receive the data voltage V1 for the first pixel circuit PC1 and the data voltage V2 for the second pixel circuit PC2, respectively.

In a period PE the emission signal EM may be at an activation level (e.g., a logic low level), the fifth transistor T5 and the sixth transistor T6 may be turned on, and a current path of the driving current through the fifth transistor T5, the first transistor T1, the sixth transistor T6, and the light-emitting element LE may be formed (or provided) from the first power voltage ELVDD to the second power voltage ELVSS. The driving current may be based on the data voltage VDAT, and the light-emitting element LE may emit light with a luminance based on the driving current.

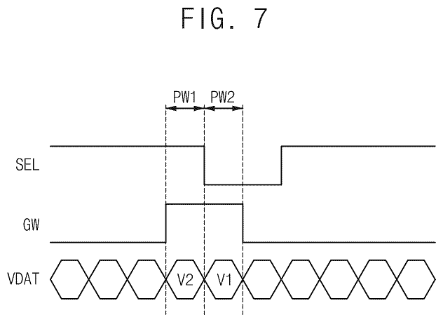

FIG. 6 is a circuit diagram illustrating an example of the first pixel circuit PC1 and the second pixel circuit PC2 of FIG. 1. FIG. 7 is a timing diagram illustrating examples of signals SEL, GW, and VDAT that may be applied to the first pixel circuit PC1 and/or the second pixel circuit PC2 of FIG. 6.

Referring to FIGS. 1, 6, and 7, the first pixel circuit PC1 and/or the second pixel circuit PC2 may receive the scan signal GW, the data voltage VDAT, and/or the like. The second pixel circuit PC2 may further receive the selection signal SEL. The gate signal GS may include the scan signal GW, the selection signal SEL, and/or the like. The first pixel circuit PC1 and/or the second pixel circuit PC2 may include (e.g., each include) a first transistor T1, a second transistor T2, a storage capacitor CST, and/or the like. The second pixel circuit PC2 may further include a selection transistor TS. The first pixel circuit PC1 and/or the second pixel circuit PC2 may compensate for a threshold voltage of the first transistor T1, for example in a source-follower type arrangement (e.g., the first transistor T1 connected in a source-follower configuration).

The first transistor T1 may be to control a driving current that may flow to the light-emitting element. The second transistor T2 may transmit the data voltage VDAT to a gate of the first transistor T1 based on the scan signal GW. The storage capacitor CST may store a voltage (e.g., a difference in voltage between the gate and a second terminal (e.g., a source) of the first transistor T1). The selection transistor TS may connect the data line DL and a first terminal (e.g., a source) of the second transistor T2 of the second pixel circuit PC2 based on the selection signal SEL.

In a period PW1 the scan signal GW may go to an activation level (e.g., a logic low level), and the selection signal SEL may be at a logic high level, the data line DL may transmit the data voltage V2 for the second pixel circuit PC2, and the second transistor T2 and the selection transistor TS may be turned on. Accordingly, the data voltage V2 may be stored in the storage capacitor CST of the first pixel circuit PC1 through the second transistor T2 of the first pixel circuit PC1, the data voltage V2 may be stored in the storage capacitor CST of the second pixel circuit PC2 through the selection transistor TS and the second transistor T2 of the second pixel circuit PC2, and the data voltage V2 for the second pixel circuit PC2 may be written to the first pixel circuit PC1 and the second pixel circuit PC2.

In a period PW2 the scan signal GW may be at the activation level and the selection signal SEL may be at a logic low level, the data line DL may transmit the data voltage V1 for the first pixel circuit PC1, the second transistor T2 may be turned on, and the selection transistor TS may be turned off. Accordingly, the data voltage V1 may be stored in the storage capacitor CST of the first pixel circuit PC1 through the second transistor T2 of the first pixel circuit PC1, and the data voltage V1 for the first pixel circuit PC1 may be written to the first pixel circuit PC1.

In one or more embodiments, the second transistor T2 may be turned on in a period, and the selection transistor TS (arranged between the second transistor T2 of the second pixel circuit PC2 and the data line DL) may receive the selection signal SEL that changes from the logic high level to the logic low level, the first pixel circuit PC1 and the second pixel circuit PC2 connected to (e.g., sharing) the data line DL may receive the data voltage V1 for the first pixel circuit PC1 and the data voltage V2 for the second pixel circuit PC2, respectively.

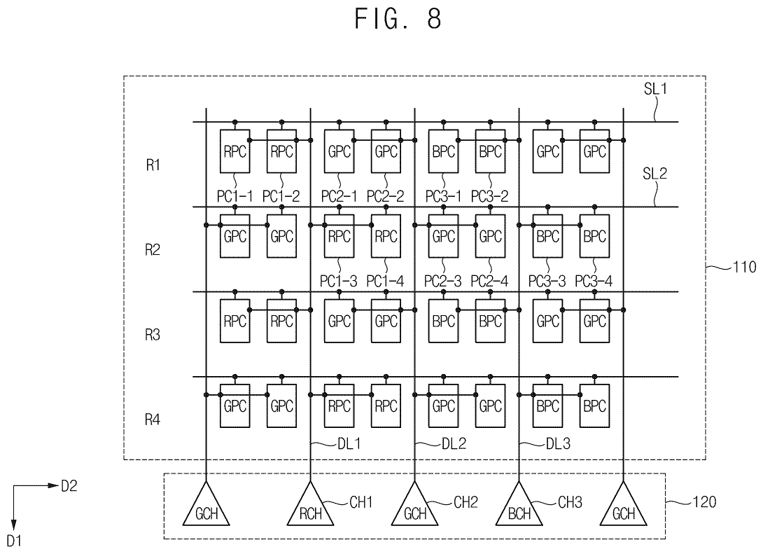

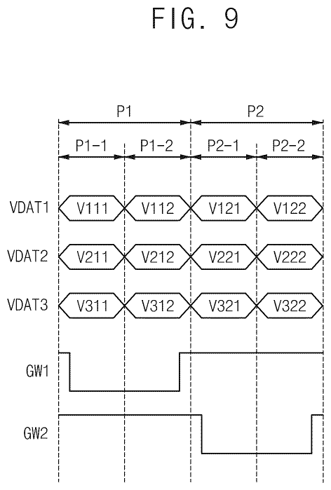

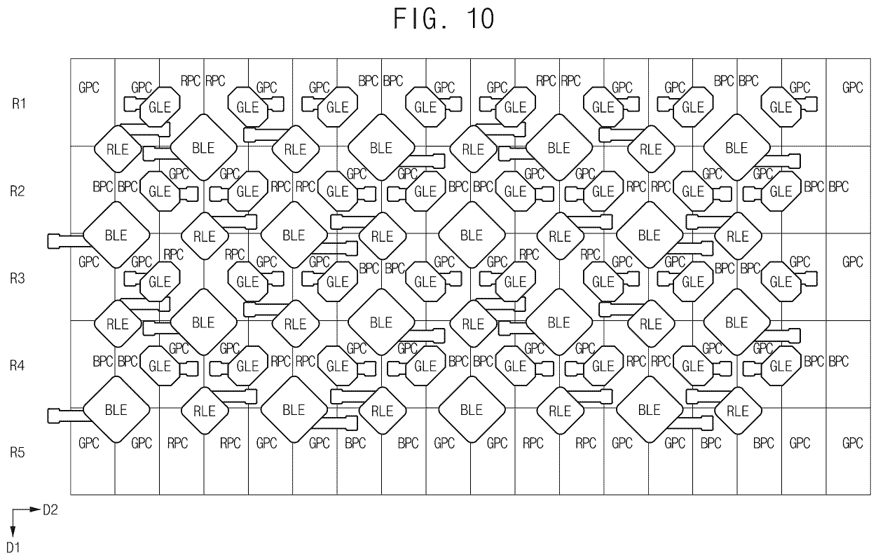

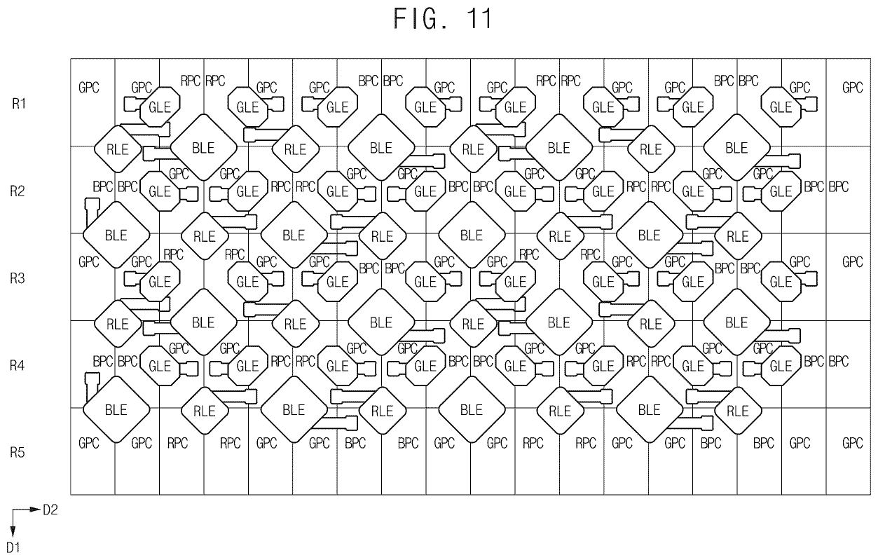

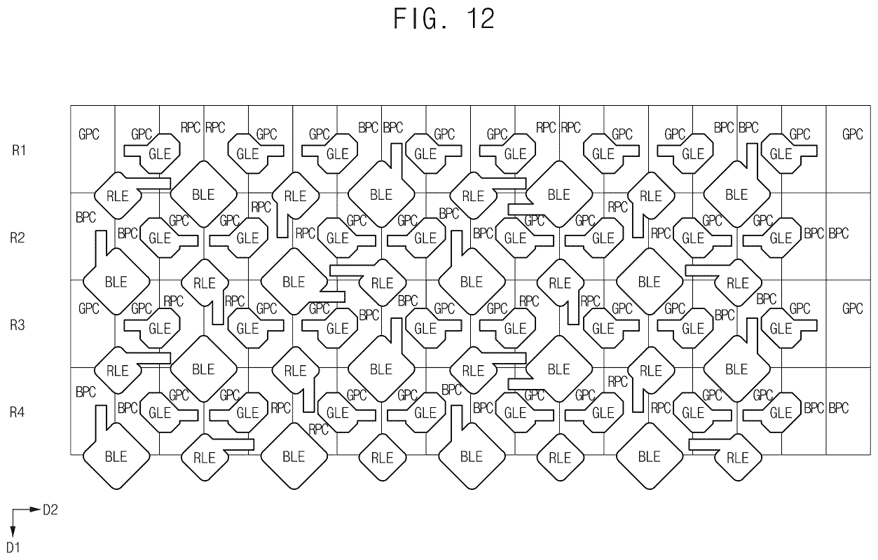

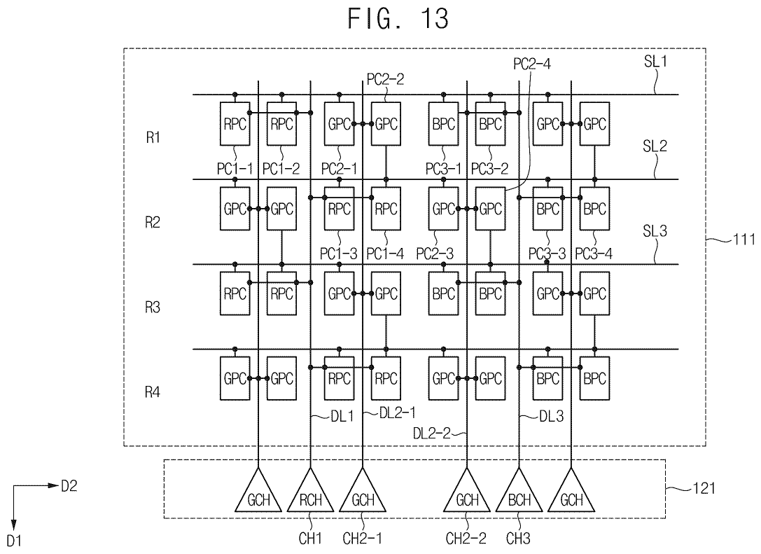

FIG. 8 is a diagram illustrating a display panel 110 and a data driver 120 according to one or more embodiments. FIG. 9 is a timing diagram illustrating examples of data voltages VDAT1, VDAT2, and VDAT3 that may be transmitted by data lines DL1, DL2, and DL3 of FIG. 8 and scan signals GW1 and GW2 that may be transmitted by scan lines SL1 and SL2 of FIG. 8. FIG. 10 is a diagram illustrating examples of pixel circuits RPC, GPC, and BPC and light-emitting elements RLE, GLE, and BLE according to one or more embodiments. FIG. 11 is a diagram illustrating examples of pixel circuits RPC, GPC, and BPC and light-emitting elements RLE, GLE, and BLE according to one or more embodiments. FIG. 12 is a diagram illustrating examples of pixel circuits RPC, GPC, and BPC and light-emitting elements RLE, GLE, and BLE according to one or more embodiments.

Referring to FIGS. 8 to 12, the data driver 120 may include a plurality of channels RCH, GCH, and BCH. One or more of the channels RCH, GCH, and BCH may output a data voltage for one color. In one or more embodiments, the channels RCH, GCH, and BCH may include red channels RCH that output a red data voltage for red, green channels GCH that output a green data voltage for green, and blue channels BCH that output a blue data voltage for blue.

The data driver 120 may include a first channel CH1, a second channel CH2, and a third channel CH3. The first channel CH1 may output a first data voltage VDAT1 for a first color, the second channel CH2 may output a second data voltage VDAT2 for a second color that may be substantially different from the first color, and the third channel CH3 may output a third data voltage VDAT3 for a third color that may be substantially different from the first color and the second color. In one or more embodiments, the first color, the second color, and the third color may be red, green, and blue, respectively.

The display panel 110 may include a plurality of data lines . . . , DL1, DL2, DL3, . . . , a plurality of scan lines SL1, SL2, . . . , a plurality of pixel circuits RPC, GPC, and BPC, and a plurality of light-emitting elements RLE, GLE, and BLE. The data lines. . . . DL1, DL2, DL3, . . . may be connected to the channels RCH, GCH, and BCH, respectively. The data lines . . . , DL1, DL2, DL3, . . . may extend in a first direction D1 (e.g., a vertical direction), and/or in one or more embodiments may be arranged in a second direction D2 (e.g., a horizontal direction) that may cross or intersect (e.g., may be substantially perpendicular to) the first direction D1. The scan lines SL1, SL2, . . . may extend in a second direction D2 (e.g., a horizontal direction), and/or in one or more embodiments may be arranged in a first direction D1 (e.g., a vertical direction).

One or more of the pixel circuits RPC, GPC, and BPC may be connected to a corresponding data line from among the data lines . . . , DL1, DL2, DL3, . . . and a corresponding scan line from among the scan lines SL1, SL2, . . . . In one or more embodiments, the pixel circuits RPC, GPC, and BPC may include red pixel circuits RPC that may receive a red data voltage, green pixel circuits GPC that may receive a green data voltage, and blue pixel circuits BPC that may receive a blue data voltage.

One or more of the light-emitting elements RLE, GLE, and BLE may be connected to a corresponding pixel circuit from among the pixel circuits RPC, GPC, and BPC. In one or more embodiments, the light-emitting elements RLE, GLE, and BLE may include red light-emitting elements RLE that may emit red light, green light-emitting elements GLE that may emit green light, and blue light-emitting elements BLE that may emit blue light. One or more of the red light-emitting elements RLE may be connected to a corresponding red pixel circuit from among the red pixel circuits RPC, one or more of the green light-emitting elements GLE may be connected to a corresponding green pixel circuit from among the green pixel circuits GPC, and one or more of the blue light-emitting elements BLE may be connected to a corresponding blue pixel circuit from among the blue pixel circuits BPC.

The display panel 110 may include a first data line DL1, a second data line DL2, a third data line DL3, a first scan line SL1, a second scan line SL2, a first-first pixel circuit PC1-1, a first-second pixel circuit PC1-2, a first-third pixel circuit PC1-3, a first-fourth pixel circuit PC1-4, a second-first pixel circuit PC2-1, a second-second pixel circuit PC2-2, a second-third pixel circuit PC2-3, a second-fourth pixel circuit PC2-4, a third-first pixel circuit PC3-1, a third-second pixel circuit PC3-2, a third-third pixel circuit PC3-3, a third-fourth pixel circuit PC3-4, first light-emitting elements, second light-emitting elements, and third light-emitting elements. One or more of the first-first pixel circuit PC1-1, the first-third pixel circuit PC1-3, the second-first pixel circuit PC2-1, the second-third pixel circuit PC2-3, the third-first pixel circuit PC3-1, and the third-third pixel circuit PC3-3 may correspond to the first pixel circuit PC1 of FIGS. 2 and 6, and one or more of the first-second pixel circuit PC1-2, the first-fourth pixel circuit PC1-4, the second-second pixel circuit PC2-2, the second-fourth pixel circuit PC2-4, the third-second pixel circuit PC3-2, and the third-fourth pixel circuit PC3-4 may correspond to the second pixel circuit PC2 of FIGS. 2 and 6.

The first data line DL1 may be connected to the first channel CH1 and may transmit the first data voltage VDAT1. The second data line DL2 may be connected to the second channel CH2, and may transmit the second data voltage VDAT2. The third data line DL3 may be connected to the third channel CH3 and may transmit the third data voltage VDAT3.

The first scan line SL1 may be arranged in a row R1 (e.g., a first row) and may transmit a first scan signal GW1. The second scan line SL2 may be arranged in another row R2 (e.g., a second row) and may transmit a second scan signal GW2.

The first-first pixel circuit PC1-1 and the first-second pixel circuit PC1-2 may be arranged in the row R1, may be connected to the first data line DL1, and may be positioned at a side (e.g., a first side and/or left side) of the first data line DL1 in the second direction D2 (e.g., a horizontal direction). The first-third pixel circuit PC1-3 and the first-fourth pixel circuit PC1-4 may be arranged in another row R2, and may be connected to the first data line DL1, and may be positioned at another side (e.g., a second side and/or right side) of the first data line DL1 (opposite to the first side of the first data line DL1) in the second direction D2. The first light-emitting elements may be connected to the first-first pixel circuit PC1-1, the first-second pixel circuit PC1-2, the first-third pixel circuit PC1-3, and the first-fourth pixel circuit PC1-4, respectively. The first light-emitting elements may be included in the red light-emitting elements RLE.

The second-first pixel circuit PC2-1 and the second-second pixel circuit PC2-2 may be arranged in the row R1, may be connected to the second data line DL2, and may be positioned at a side (e.g., a first side and/or left side) of the second data line DL2 in the second direction D2. The second-third pixel circuit PC2-3 and the second-fourth pixel circuit PC2-4 may be arranged in the row R2, may be connected to the second data line DL2, and may be positioned at another side (e.g., a second side and/or right side) of the second data line DL2 (e.g., opposite to the first side of the second data line DL2) in the second direction D2. The second light-emitting elements may be connected to the second-first pixel circuit PC2-1, the second-second pixel circuit PC2-2, the second-third pixel circuit PC2-3, and the second-fourth pixel circuit PC2-4, respectively. The second light-emitting elements may be included in the green light-emitting elements GLE.

The third-first pixel circuit PC3-1 and the third-second pixel circuit PC3-2 may be arranged in the row R1, may be connected to the third data line DL3, and may be positioned at a side (e.g., a first side and/or left side) of the third data line DL3 in the second direction D2. The third-third pixel circuit PC3-3 and the third-fourth pixel circuit PC3-4 may be arranged in the row R2, may be connected to the third data line DL3, and may be positioned at another side (e.g., a second side and/or right side) of the third data line DL3 (e.g., opposite to the first side of the third data line DL3) in the second direction D2. The third light-emitting elements may be connected to the third-first pixel circuit PC3-1, the third-second pixel circuit PC3-2, the third-third pixel circuit PC3-3, and the third-fourth pixel circuit PC3-4, respectively. The third light-emitting elements may be included in the blue light-emitting elements BLE.

The first-first pixel circuit PC1-1, the first-second pixel circuit PC1-2, the second-first pixel circuit PC2-1, the second-second pixel circuit PC2-2, the third-first pixel circuit PC3-1, and the third-second pixel circuit PC3-2 may be connected to the first scan line SL1, and may receive the first scan signal GW1. The first-third pixel circuit PC1-3, the first-fourth pixel circuit PC1-4, the second-third pixel circuit PC2-3, the second-fourth pixel circuit PC2-4, the third-third pixel circuit PC3-3, and the third-fourth pixel circuit PC3-4 may be connected to the second scan line SL2, and may receive the second scan signal GW2.

In a first-first period P1-1 (e.g., within a first period P1) the first scan signal GW1 may go to an activation level, the first channel CH1 may output a data voltage V111 (e.g., a first data voltage) for the first-first pixel circuit PC1-1, the second channel CH2 may output a data voltage V211 (e.g., a second data voltage) for the second-first pixel circuit PC2-1, and the third channel CH3 may output a data voltage V311 (e.g., a third data voltage) for the third-first pixel circuit PC3-1. Accordingly, in the first-first period P1-1, the data voltage V111 may be written to the first-first pixel circuit PC1-1, the data voltage V211 may be written to the second-first pixel circuit PC2-1, and the data voltage V311 may be written to the third-first pixel circuit PC3-1.

In a first-second period P1-2 (e.g., within the first period P1 and following the first-first period P1-1), the first channel CH1 may output a data voltage V112 (e.g., a first data voltage) for the first-second pixel circuit PC1-2, the second channel CH2 may output a data voltage V212 (e.g., a second data voltage) for the second-second pixel circuit PC2-2, and the third channel CH3 may output a data voltage V312 (e.g., a third data voltage) for the third-second pixel circuit PC3-2. Accordingly, in the first-second period P1-2, the data voltage V112 may be written to the first-second pixel circuit PC1-2, the data voltage V212 may be written to the second-second pixel circuit PC2-2, and the data voltage V312 may be written to the third-second pixel circuit PC3-2.

In a second-first period P2-1 (e.g., within a second period P2) the second scan signal GW2 may go to an activation level, the first channel CH1 may output a data voltage V121 (e.g., a first data voltage) for the first-third pixel circuit PC1-3, the second channel CH2 may output a data voltage V221 (e.g., a second data voltage) for the second-third pixel circuit PC2-3, and the third channel CH3 may output a data voltage V321 (e.g., a third data voltage) for the third-third pixel circuit PC3-3. Accordingly, in the second-first period P2-1, the data voltage V121 may be written to the first-third pixel circuit PC1-3, the data voltage V221 may be written to the second-third pixel circuit PC2-3, and the data voltage V321 may be written to the third-third pixel circuit PC3-3.

In a second-second period P2-2 (e.g., within the second period P2 and following the second-first period P2-1), the first channel CH1 may output a data voltage V122 (e.g., a first voltage) for the first-fourth pixel circuit PC1-4, the second channel CH2 may output a data voltage V222 (e.g., a second voltage) for the second-fourth pixel circuit PC2-4, and the third channel CH3 may output a data voltage V322 (e.g., a third voltage) for the third-fourth pixel circuit PC3-4. Accordingly, in the second-second period P2-2, the data voltage V122 may be written to the first-fourth pixel circuit PC1-4, the data voltage V222 may be written to the second-fourth pixel circuit PC2-4, and the data voltage V322 may be written to the third-fourth pixel circuit PC3-4.

In one or more embodiments, two pixel circuits arranged in a row (e.g., one row) may be connected to a data line (e.g., one data line), so that the number of channels of the data driver 120 may be reduced, and a dead space of the display device may be reduced. Further, in or more embodiments, a channel of the data driver 120 may output a data voltage for one color, so that power consumption of the channel may be reduced, and power consumption of the display device may be reduced.

In one or more embodiments, as illustrated in FIGS. 10 and 11, one or more of the light-emitting element RLE (e.g., first light-emitting elements) and the light-emitting element GLE (e.g., second light-emitting elements) may be arranged in a row (e.g., the same row) with one or more of the pixel circuits RPC and GPC respectively connected thereto, and one or more of the third light-emitting elements BLE may be arranged in another row (e.g., in a different row from the row of the pixel circuit BPC connected thereto).

For example, if the red light-emitting element RLE is arranged in a k^{th} row (k may refer to natural number greater than or equal to 1), the red pixel circuit RPC connected thereto may be arranged in the k^{th} row (as used herein, “if” may mean “when,” as appropriate). For example, when the green light-emitting element GLE is arranged in the k^{th} row, the green pixel circuit GPC connected thereto may be arranged in the k^{th} row. For example, when the blue light-emitting element BLE is arranged in the k^{th} row, the blue pixel circuit BPC connected thereto may be arranged in a k+1^{th} row.

In one or more embodiments, as illustrated in FIG. 11, one or more of the light-emitting elements BLE (e.g., third light-emitting elements) arranged at a side (e.g., an outermost side in the second direction D2) may overlap (e.g., at least partially overlap) the pixel circuit BPC connected thereto, and may be arranged in the row (e.g., same row) where the pixel circuit BPC connected thereto is arranged. For example, when the blue light-emitting element BLE arranged at the side in the second direction D2 is arranged in the k^{th} row, the blue pixel circuit BPC connected thereto may overlap the blue light-emitting element BLE, and may be arranged in the k^{th} row. In this case, an area in which the pixel circuits are arranged may be reduced, and a dead space of the display device, for example in the second direction D2, may be reduced.

In one or more embodiments, as illustrated in FIG. 12, one or more of the light-emitting elements GLE (e.g., second light-emitting elements) may be arranged in the row (e.g., same row) with the pixel circuit GPC connected thereto, and one or more of the light-emitting elements RLE and the light-emitting elements BLE may be arranged in the same row as and/or a different row from a row with the pixel circuit RPC and BPC connected thereto. For example, when the red light-emitting element RLE is arranged in the k^{th} row, the red pixel circuit RPC connected thereto may be arranged in the k^{th} row or the k+1^{th} row. For example, when the green light-emitting element GLE is arranged in the k^{th} row, the green pixel circuit GPC connected thereto may be arranged in the k^{th} row. For example, when the blue light-emitting element BLE is arranged in the k^{th} row, the blue pixel circuit BPC connected thereto may be arranged in the k^{th} row or the k+1^{th} row.

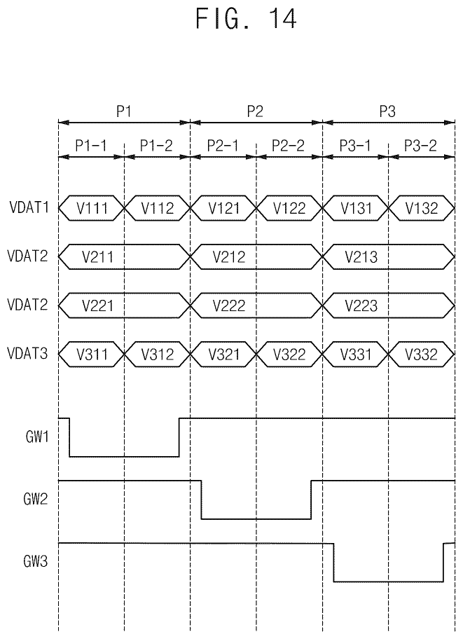

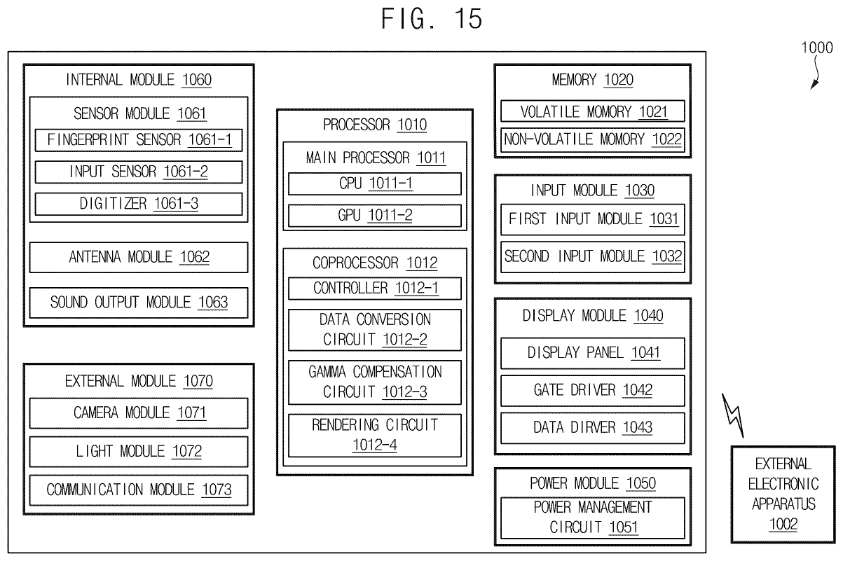

FIG. 13 is a diagram illustrating an example of a display panel 111 and a data driver 121 according to one or more embodiments. FIG. 14 is a timing diagram illustrating examples of data voltages VDAT1, VDAT2, and VDAT3 that may be transmitted by data lines DL1, DL2-1, DL2-2, and DL3 of FIG. 13 and scan signals GW1, GW2, and GW3 that may be transmitted by scan lines SL1, SL2, and SL3 of FIG. 13.

Descriptions of components of the display panel 111 and data driver 121 described with reference to FIGS. 13 and 14, which are substantially the same as or similar to those of the display panel 110 and data driver 120 described with reference to FIGS. 8 to 12, are omitted.

Referring to FIGS. 13 and 14, the data driver 121 may include a first channel CH1, a second-first channel CH2-1, a second-second channel CH2-2, and a third third channel CH3. The first channel CH1 may output a first data voltage VDAT1 for a first color, one or more of the second-first channel CH2-1 and/or the second-second channel CH2-2 may output a second data voltage VDAT2 for a second color that may be different from the first color, and the third third channel CH3 may output a third third data voltage VDAT3 for a third color that may be different from the first color and the second color.

The display panel 111 may include a first data line DL1, a second-first data line DL2-1, a second-second data line DL2-2, a third third data line DL3, a first scan line SL1, a second scan line SL2, a third scan line SL3, a first-first pixel circuit PC1-1, a first-second pixel circuit PC1-2, a first-third pixel circuit PC1-3, a first-fourth pixel circuit PC1-4, a second-first pixel circuit PC2-1, a second-second pixel circuit PC2-2, a second-third pixel circuit PC2-3, a second-fourth pixel circuit PC2-4, a third-first pixel circuit PC3-1, a third-second pixel circuit PC3-2, a third-third pixel circuit PC3-3, a third-fourth pixel circuit PC3-4, first light-emitting elements, second-first light-emitting elements, second-second light-emitting elements, and third light-emitting elements. One or more of the first-first pixel circuit PC1-1, the first-third pixel circuit PC1-3, the third-first pixel circuit PC3-1, and the third-third pixel circuit PC3-3 may correspond to the first pixel circuit PC1 of FIGS. 2 and 6, and one or more of the first-second pixel circuit PC1-2, the first-fourth pixel circuit PC1-4, the third-second pixel circuit PC3-2, and the third-fourth pixel circuit PC3-4 may correspond to the second pixel circuit PC2 of FIGS. 2 and 6.

The second-first data line DL2-1 may be connected to the second-first channel CH2-1 and may transmit the second data voltage VDAT2. The second-second data line DL2-2 may be connected to the second-second channel CH2-2 and may transmit the second data voltage VDAT2.

The third scan line SL3 may be arranged in a row R3, and may transmit a third scan signal GW3.

The second-first pixel circuit PC2-1 and the second-second pixel circuit PC2-2 may be arranged in the row R1, may be connected to the second-first data line DL2-1, and may be positioned with the second-first data line DL2-1 interposed therebetween (e.g., arranged on opposite sides of the second-first data line DL2-1). The second-first light-emitting elements may be connected to the second-first pixel circuit PC2-1 and the second-second pixel circuit PC2-2, respectively. The second-first light-emitting elements may be included in the green light-emitting elements GLE.

The second-third pixel circuit PC2-3 and the second-fourth pixel circuit PC2-4 may be arranged in the row R2, may be connected to the second-second data line DL2-2, and may be position with the second-second data line DL2-2 interposed therebetween (e.g., arranged on opposite sides of the second-second data line DL2-2). The second-second light-emitting elements may be connected to the second-third pixel circuit PC2-3 and the second-fourth pixel circuit PC2-4, respectively. The second-second light-emitting elements may be included in the green light-emitting elements GLE.

The second-first pixel circuit PC2-1 may be connected to the first scan line SL1 and may receive the first scan signal GW1. The second-second pixel circuit PC2-2 and the second-third pixel circuit PC2-3 may be connected to the second scan line SL2, and may receive the second scan signal GW2. The second-fourth pixel circuit PC2-4 may be connected to the third scan line SL3 and may receive the third scan signal GW3.

In a first period P1 the first scan signal GW1 may go to an activation level, the second-first channel CH2-1 may output a second data voltage V211 for the second-first pixel circuit PC2-1. Accordingly, in the first period P1, the second data voltage V211 may be written to the second-first pixel circuit PC2-1.

In a second period P2 the second scan signal GW2 may go to an activation level, the second-first channel CH2-1 may output a second data voltage V212 for the second-second pixel circuit PC2-2, and the second-second channel CH2-2 may output a second data voltage V222 for the second-third pixel circuit PC2-3. Accordingly, in the second period P2, the second data voltage V212 may be written to the second-second pixel circuit PC2-2, and the second data voltage V222 may be written to the second-third pixel circuit PC2-3.

In a period P3 (e.g., third period) the third scan signal GW3 may go to an activation level, and the second-second channel CH2-2 may output a second data voltage V223 for the second-fourth pixel circuit PC2-4. Accordingly, in period P3, the second data voltage V223 may be written to the second-fourth pixel circuit PC2-4.

A visual sensitivity (e.g., perception by the human eye) to green light may be relatively higher than a visual sensitivity to red light and/or a visual sensitivity to blue light. Accordingly, when a change and/or deviation in luminance of the green light occurs, display quality of the display device may be reduced (e.g., deteriorate). In embodiments of the present disclosure, a charging time (for example, approximately 1 horizontal time (1 H)) of the second data voltage VDAT2 written to the green pixel circuit GPC may be relatively greater (e.g., increased, longer, etc.) than a charging time (for example, approximately 0.5 horizontal time (0.5 H)) of one or more of the first data voltage VDAT1 written to the red pixel circuit RPC and the third third data voltage VDAT3 written to the blue pixel circuit BPC, so that the luminance deviation of the green light may be reduced, and the display quality of the display device may be improved and/or increased.

FIG. 15 is a block diagram illustrating an electronic apparatus 1000 according to one or more embodiments.

Referring to FIG. 15, the electronic apparatus 1000 may output various information through a display module 1040 within operating system. When a processor 1010 executes an application stored in a memory 1020, the display module 1040 may provide application information to a user through a display panel 1041. In one or more embodiments, the processor 1010 may output the image data IMG of FIG. 1, the controller control signal CTRL of FIG. 1, etc. to the display module 1040.

The processor 1010 may obtain an external input through an input module 1030 or a sensor module 1061, and may execute an application corresponding to the external input. For example, when the user selects a camera icon displayed on the display panel 1041, the processor 1010 may obtain a user input through an input sensor 1061-2, and may activate a camera module 1071. The processor 1010 may transmit image data corresponding to a captured image acquired through the camera module 1071 to the display module 1040. The display module 1040 may display an image corresponding to the captured image through the display panel 1041. Some of components of the electronic apparatus 1000 may be integrated and provided as one component, or one component may be provided separately into two or more components.

The electronic apparatus 1000 may communicate with an external electronic apparatus 1002 through a network (e.g., a short-range wireless communication network or a long-range wireless communication network). In an embodiment, the electronic apparatus 1000 may include the processor 1010, the memory 1020, the input module 1030, the display module 1040, a power module 1050, an internal module 1060, and an external module 1070. In an embodiment, the electronic apparatus 1000 may omit at least one of the above-described components, or one or more other components may be added. In an embodiment, some of the above-described components (e.g., a sensor module 1061, an antenna module 1062, or a sound output module 1063) may be integrated into another component (e.g., the display module 1040).

The processor 1010 may execute software to control at least one other component (e.g., hardware or software component) of the electronic apparatus 1000 connected to the processor 1010, and may perform various data processing or calculation. In an embodiment, as at least part of data processing or calculation, the processor 1010 may store commands or data received from another component (e.g., the input module 1030, the sensor module 1061, or a communication module 1073) in a volatile memory 1021, may process the commands or data stored in the volatile memory 1021, and may store resultant data in a non-volatile memory 1022.

The processor 1010 may include a main processor 1011 and a coprocessor 1012. The main processor 1011 may include one or more of a central processing unit (CPU) 1011-1 or an application processor (AP). The main processor 1011 may further include one or more of a graphics processing unit (GPU) 1011-2, a communication processor (CP), and an image signal processor (ISP). At least two of the above-described processing unit and processor may be implemented as an integrated component (e.g., a single chip), or each may be implemented as an independent component (e.g., a plurality of chips).

The coprocessor 1012 may include a controller 1012-1. The controller 1012-1 may include an interface conversion circuit and a timing control circuit. The controller 1012-1 may receive an image signal from the main processor 1011, may convert data format of the image signal to suit the interface specifications with the display module 1040, and may output image data. The controller 1012-1 may output various control signals necessary for driving the display module 1040.

The coprocessor 1012 may further include a data conversion circuit 1012-2, a gamma correction circuit 1012-3, a rendering circuit 1012-4, etc. The data conversion circuit 1012-2 may receive the image data from the controller 1012-1, and may compensate the image data such that the image is displayed at a desired luminance according to the characteristics of the electronic apparatus 1000 or the user's settings or may convert the image data to reduce power consumption or compensate for afterimages. The gamma correction circuit 1012-3 may convert the image data or a gamma reference voltage such that an image displayed on the electronic apparatus 1000 has desired gamma characteristics. The rendering circuit 1012-4 may receive the image data from the controller 1012-1, and may render the image data by considering a pixel arrangement of the display panel 1041 applied to the electronic apparatus 1000. At least one of the data conversion circuit 1012-2, the gamma correction circuit 1012-3, or the rendering circuit 1012-4 may be integrated into another component (e.g., the main processor 1011 or a controller). At least one of the data conversion circuit 1012-2, the gamma correction circuit 1012-3, or the rendering circuit 1012-4 may be integrated into a data driver 1043 to be described below.

The memory 1020 may store various data used by at least one component of the electronic apparatus 1000 (e.g., the processor 1010 or the sensor module 1061) and input data or output data for commands related thereto. The memory 1020 may include at least one of the volatile memory 1021 or the non-volatile memory 1022.

The input module 1030 may receive commands or data to be used in components of the electronic apparatus 1000 (e.g., the processor 1010, the sensor module 1061, or the sound output module 1063) from the outside of the electronic apparatus 1000 (e.g., the user or the external electronic apparatus 1002).

The input module 1030 may include a first input module 1031 through which commands or data are input from the user, and a second input module 1032 through which command or data are input from the external electronic apparatus 1002. The first input module 1031 may include a microphone, a mouse, a keyboard, a key (e.g., button), or a pen (e.g., passive pen or active pen). The second input module 1032 may support a designated protocol that may connect to the external electronic apparatus 1002 by wire or wirelessly. In an embodiment, the second input module 1032 may include a high-definition multimedia interface (HDMI), a universal serial bus (USB) interface, an SD card interface, or an audio interface. The second input module 1032 may include a connector that may be physically connected to the external electronic apparatus 1002, for example, an HDMI connector, a USB connector, an SD card connector, or an audio connector (e.g., a headphone connector).

The display module 1040 may provide visual information to the user. The display module 1040 may include the display panel 1041, a gate driver 1042, and the data driver 1043. The display module 1040 may further include a window, a chassis, and a bracket to protect the display panel 1041. The display module 1040 may correspond to the display device 100 of FIG. 1. The display panel 1041, the gate driver 1042, and the data driver 1043 may correspond to the display panel 110 of FIG. 1, the gate driver 130 of FIG. 1, and the data driver 120 of FIG. 1, respectively.

The power module 1050 may supply power to components of the electronic apparatus 1000. The power module 1050 may include a battery that charges power voltage. The battery may include a non-rechargeable primary cell, a rechargeable secondary cell, or a fuel cell. The power module 1050 may include a power management circuit 1051. The power management circuit 1051 may supply optimized power to each of the above-described modules and the modules described below. The power module 1050 may include a wireless power transmission/reception member electrically connected to the battery. The wireless power transmission/reception member may include a plurality of coil-shaped antenna radiators.

The electronic apparatus 1000 may further include the internal module 1060 and the external module 1070. The internal module 1060 may include the sensor module 1061, the antenna module 1062, and the sound output module 1063. The external module 1070 may include the camera module 1071, a light module 1072, and a communication module 1073.

The sensor module 1061 may detect an input by the user's body or an input by the pen among the first input module 1031, and may generate an electrical signal or a data value corresponding to the input. The sensor module 1061 may include at least one of a fingerprint sensor 1061-1, an input sensor 1061-2, or a digitizer 1061-3.

The processor 1010 may output commands or data to the display module 1040, the sound output module 1063, the camera module 1071, or the light module 1072 based on the input data received from the input module 1030. For example, the processor 1010 may generate image data in response to input data applied through the mouse or the active pen and output the image data to the display module 1040, or may generate command data in response to the input data to output the command data to the camera module 1071 or the light module 1072. When no input data is received from the input module 1030 for a certain period of time, the processor 1010 may switch an operation mode of the electronic apparatus 1000 to a low-power mode or a sleep mode to reduce power consumption of the electronic apparatus 1000.

The processor 1010 may output commands or data to the display module 1040, the sound output module 1063, the camera module 1071, or the light module 1072 based on sensing data received from the sensor module 1061. For example, the processor 1010 may compare authentication data authorized by the fingerprint sensor 1061-1 with authentication data stored in the memory 1020, and then may execute an application according to the comparison result. The processor 1010 may execute command or output corresponding image data to the display module 1040 based on sensing data detected by the input sensor 1061-2 or the digitizer 1061-3. When the sensor module 1061 includes a temperature sensor, the processor 1010 may receive temperature data for a temperature measured from the sensor module 1061, and may further perform luminance correction for the image data or the like based on the temperature data.

In the display panel 1041 included in the display module 1040, two pixel circuits arranged in one row may be connected to one data line, so that the number of channels of the data driver 1043 may be reduced, and a dead space of the display panel 1041 may be reduced. In the display module 1040, the channel of the data driver 1043 outputs a data voltage for one color, so that power consumption of the data driver 1043 may be reduced, and power consumption of the display module 1040 may be reduced.

The display device according to the embodiments may be applied to a display device included in a computer, a notebook, a mobile phone, a smart phone, a smart pad, a smart watch, a PMP, a PDA, an MP3 player, and/or the like.

Although the display panel, the display device, and the electronic apparatus according to the embodiments have been described with reference to the drawings, the descriptions are illustrative of the present disclosure and are not to be construed as limiting thereof. Although one or more example embodiments of the present disclosure have been described, those skilled in the art will readily appreciate that many modifications are possible in the example embodiments without materially departing from the aspects of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific example embodiments disclosed, and that modifications to the disclosed example embodiments, as well as other example embodiments, are intended to be included within the scope of the appended claims. The present disclosure is defined by the following claims, with functional equivalents of the claims to be included therein.

What is claimed is:

1. A display panel comprising:
a data line configured to transmit a data voltage for a color;
a first pixel circuit and a second pixel circuit connected to the data line and positioned at a side of the data line; and
one or more light-emitting elements connected to the first pixel circuit and the second pixel circuit,
wherein the first pixel circuit and the second pixel circuit comprise:
a first transistor configured to control a driving current flowing to a corresponding light-emitting element of the one or more light-emitting elements;
a second transistor configured to transmit the data voltage to a first terminal of the first transistor based on a scan signal;
a third transistor configured to connect a second terminal and a gate of the first transistor based on the scan signal; and
a selection transistor configured to connect the first terminal of the first transistor and a terminal of the second transistor based on a selection signal.

2. The display panel of claim 1, wherein the data voltage is configured to be written to the first pixel circuit in a period that the scan signal is at an activation level and the selection signal is at a logic low level,
wherein the data voltage is configured to be written to the second pixel circuit in a period that the scan signal is at the activation level and the selection signal is at a logic high level,
wherein the selection transistor of the first pixel circuit comprises a P-type Metal Oxide Semiconductor (PMOS) transistor, and
wherein the selection transistor of the second pixel circuit comprises an N-type Metal Oxide Semiconductor (NMOS) transistor.

3. The display panel of claim 1, wherein the first pixel circuit and the second pixel circuit further comprise:
a storage capacitor configured to store a signal of the gate of the first transistor;
a fourth transistor configured to initialize the storage capacitor based on an initialization gate signal;
a fifth transistor configured to transmit a power voltage to the first terminal of the first transistor based on an emission signal;
a sixth transistor configured to connect the second terminal of the first transistor and a terminal of the corresponding light-emitting element based on the emission signal; and
a seventh transistor configured to initialize the corresponding light-emitting element based on a bypass gate signal.

4. A display device comprising:
a data driver comprising a first channel configured to output a first data voltage for a first color, and a second channel configured to output a second data voltage for a second color;
a first data line connected to the first channel and configured to transmit the first data voltage;
a second data line configured to transmit the second data voltage;
a first-first pixel circuit and a first-second pixel circuit arranged in a first row, connected to the first data line, and positioned at a first side of the first data line;
a first-third pixel circuit and a first-fourth pixel circuit arranged in a second row, connected to the first data line, and positioned at a second side of the first data line; and
first light-emitting elements connected to the first-first pixel circuit, the first-second pixel circuit, the first-third pixel circuit, and the first-fourth pixel circuit.

5. The display device of claim 4, further comprising:
a second-first pixel circuit and a second-second pixel circuit arranged in the first row, connected to the second data line, and positioned at a first side of the second data line;
a second-third pixel circuit and a second-fourth pixel circuit arranged in the second row, connected to the second data line, and positioned at a second side of the second data line; and
second light-emitting elements connected to the second-first pixel circuit, the second-second pixel circuit, the second-third pixel circuit, and the second-fourth pixel circuit.

6. The display device of claim 5, further comprising:
a first scan line in the first row, and connected to the first-first pixel circuit, the first-second pixel circuit, the second-first pixel circuit, and the second-second pixel circuit; and
a second scan line in the second row, and connected to the first-third pixel circuit, the first-fourth pixel circuit, the second-third pixel circuit, and the second-fourth pixel circuit.

7. The display device of claim 5, further comprising:
a third data line configured to transmit a third data voltage for a third color;
a third-first pixel circuit and a third-second pixel circuit arranged in the first row, connected to the third data line, and positioned at a first side of the third data line;
a third-third pixel circuit and a third-fourth pixel circuit arranged in the second row, connected to the third data line, and positioned at a second side of the third data line; and
third light-emitting elements connected to the third-first pixel circuit, the third-second pixel circuit, the third-third pixel circuit, and the third-fourth pixel circuit.

8. The display device of claim 7, wherein the first light-emitting elements and the second light-emitting elements are respectively arranged in a same one of the rows as a corresponding one of the pixel circuits connected thereto, and
wherein the third light-emitting elements are respectively arranged in a different one of the rows from a corresponding one of the pixel circuits connected thereto.

9. The display device of claim 7, wherein the second light-emitting elements are respectively arranged in a same one of the rows as a corresponding one of the pixel circuits connected thereto.

10. The display device of claim 7, wherein the data driver further comprises a third channel configured to output the third data voltage, and connected to the third data line.

11. The display device of claim 4, further comprising:
a second-first data line configured to transmit the second data voltage;
a second-first pixel circuit and a second-second pixel circuit arranged in the first row, connected to the second-first data line, and positioned with the second-first data line therebetween; and
second-first light-emitting elements connected to the second-first pixel circuit and the second-second pixel circuit.

12. The display device of claim 11, further comprising:
a first scan line in the first row, and connected to the first-first pixel circuit, the first-second pixel circuit, and the second-first pixel circuit; and
a second scan line in the second row, and connected to the first-third pixel circuit, the first-fourth pixel circuit, and the second-second pixel circuit.

13. The display device of claim 11, further comprising:
a second-second data line configured to transmit the second data voltage;
a second-third pixel circuit and a second-fourth pixel circuit arranged in the second row, connected to the second-second data line, and positioned with the second-second data line therebetween; and
second-second light-emitting elements connected to the second-third pixel circuit and the second-fourth pixel circuit.

14. The display device of claim 13, wherein the data driver further comprises:
a second-first channel configured to output the second data voltage, and connected to the second-first data line; and
a second-second channel configured to output the second data voltage, and connected to the second-second data line.

15. The display device of claim 4, wherein the first-first pixel circuit and the first-second pixel circuit comprise:
a first transistor configured to control a driving current to a corresponding one of the first light-emitting elements;
a second transistor configured to transmit the first data voltage to a terminal of the first transistor based on a scan signal;
a third transistor configured to diode-connect the first transistor based on the scan signal; and
a selection transistor configured to connect the terminal of the first transistor and a terminal of the second transistor based on a selection signal,
wherein the selection transistor of the first-first pixel circuit comprises a P-type Metal Oxide Semiconductor (PMOS) transistor, and
wherein the selection transistor of the first-second pixel circuit comprises an N-type Metal Oxide Semiconductor (NMOS) transistor.

16. The display device of claim 15, wherein the first data voltage is configured to be written to the first-first pixel circuit in a period that the scan signal is at an activation level and that the selection signal is at a logic low level, and
wherein the first data voltage is configured to be written to the first-second pixel circuit in a period that the scan signal is at the activation level and that the selection signal is at a logic high level.

17. The display device of claim 4, wherein the first-first pixel circuit and the first-second pixel circuit comprises:
a first transistor configured to control a driving current to a corresponding one of the first light-emitting elements; and
a second transistor configured to transmit the first data voltage to a gate of the first transistor based on a scan signal, and
wherein the first-second pixel circuit further comprises a selection transistor configured to connect to the first data line and a terminal of the second transistor based on a selection signal.

18. The display device of claim 17, wherein the first data voltage is configured to be written to the first-first pixel circuit and the first-second pixel circuit in a period that the scan signal is at an activation level and that the selection signal is at a logic high level, and
wherein the first data voltage is configured to be written to the first-first pixel circuit in a period that the scan signal is at the activation level and that the selection signal is at a logic low level.

19. An electronic apparatus comprising:
a processor configured to output image data;
a data driver comprising a channel configured to output a data voltage for a color based on the image data; and
a display panel comprising a data line connected to the channel, a first pixel circuit and a second pixel circuit connected to the data line and positioned at a side of the data line, and light-emitting elements connected to the first pixel circuit and the second pixel circuit,
wherein the first pixel circuit and the second pixel circuit comprise:
a first transistor configured to control a driving current to a corresponding one of the light-emitting elements;
a second transistor configured to transmit the data voltage to a first terminal of the first transistor based on a scan signal;
a third transistor configured to connect a second terminal and a gate of the first transistor based on the scan signal; and
a selection transistor configured to connect the first terminal of the first transistor and a terminal of the second transistor based on a selection signal.

20. The electronic apparatus of claim 19, wherein the data voltage is configured to be written to the first pixel circuit in a period that the scan signal is at an activation level and that the selection signal is at a logic low level,
wherein the data voltage is written to the second pixel circuit in a period that the scan signal is at the activation level and the selection signal is at a logic high level,
wherein the selection transistor of the first pixel circuit comprises a P-type Metal Oxide Semiconductor (PMOS) transistor, and
wherein the selection transistor of the second pixel circuit comprises a N-type Metal Oxide Semiconductor (NMOS) transistor.
